(19) United States
(12) Patent Application Publication
(10) Pub. No.: US 2008/0259638 A1
(43) Pub. Date: Oct. 23, 2008

(54) OPTICAL PLATE AND BACKLIGHT MODULE USING THE SAME

(75) Inventor: SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/835,427

(22) Filed: Aug. 8, 2007

(30) Foreign Application Priority Data
Apr. 18, 2007 (CN) 200710200481.0

(51) Int. Cl. F21V 8/00; F21V 7/04

(52) U.S. Cl. 362/606; 362/619

(57) ABSTRACT

An exemplary optical plate (20) includes a light output surface, and a bottom surface opposite to the light output surface. A plurality of first protrusions are formed on the light output surface. A lamp-receiving portion is defined in the bottom surface. A backlight module (200) using the optical plate is also provided.

### CROSS-REFERENCE TO RELATED APPLICATIONS

This application is related to six copending U.S. patent applications, which are: applications serial no. [to be advised], Attorney Docket No. US13925, US13926, US13931, US14376, US14378, and US 14382, and entitled “OPTICAL PLATE AND BACKLIGHT MODULE USING THE SAME”. In all these copending applications, the inventor is Shao-Han Chang. All of the copending applications have the same assignee as the present application. The disclosures of the above identified applications are incorporated herein by reference.

### BACKGROUND OF THE INVENTION

1. Field of the Invention

The present invention relates to an optical plate, and a backlight module using the optical plate, the backlight module typically being used in apparatuses such as a liquid crystal display (LCD).

2. Discussion of the Related Art

In a liquid crystal display device, liquid crystal is a substance that does not itself radiate light. Instead, the liquid crystal relies on light received from a light source in order to provide displaying of images and data. In the case of a typical liquid crystal display device, a backlight module powered by electricity supplies the needed light.

Typically, FIG. 1 illustrates a backlight module 100. The backlight module 100 includes a housing 101, a reflective module 102, a light diffusion plate 103, a prism sheet 104, a light emitting diode 105, and a reflective sheet 106. The housing 101 includes a base 1011 and a plurality of connecting sidewalls 1013 extending from a periphery of the base 1011. The reflective module 102 is engaged with the housing 101, and located in the housing 101. The reflective module 102 defines a plurality of through holes (not labeled). The light diffusion plate 103 and the prism sheet 104 are stacked on a top of the sidewalls 1013 of the housing 101 in that order. The light emitting diode 105 includes a base portion 1053 and a light output portion 1051 disposed on the base portion 1053. The base portion 1053 is electrically connected with a printed circuit board (not labeled) that is fixed to the base 1011. The output portion 1051 of the light emitting diode 105 passes through the through hole of the reflective module 102. The reflective sheet 106 is located on a top the light output portion 1051 of the light emitting diode 105.

In use, light rays from the light emitting diode 105 are substantially reflected at the reflective module 102 and project into the light diffusion plate 103. After being scattered in the light diffusion plate 103, the light rays enter the prism sheet 104. The light rays are refracted by the prism sheet 104, and are thereby concentrated somewhat. This increases brightness of light illumination provided by the backlight module 100. Finally, the light rays propagate into an LCD panel (not shown) disposed above the prism sheet 104.

Generally, even though brightness above the light emitting diode 105 of the backlight module 100 can be decrease due to the light reflection of the reflective sheet 106, a plurality of dark areas around the light emitting diodes 105 still occur. Accordingly a brightness distribution of the backlight module 100 is still not uniform.

Therefore, what is desired is an optical plate and a backlight module using the optical plate that can overcome the above-described shortcomings.

### SUMMARY

An optical plate includes at least an optical plate unit. Each optical plate unit includes a light output surface and a bottom surface opposite to the light output surface. A plurality of first protrusions are formed on the light output surface. A lamp-receiving portion is defined in the bottom surface.

A backlight module includes a housing, at least a point light source, a light diffusion plate, a light diffusion plate, and an optical plate. The housing has a base and a plurality of sidewalls extending from a periphery of the base. The at least a point light source has a light output portion located on the base. The light diffusion plate is positioned on a top of the sidewalls. An optical plate includes at least an optical plate unit. Each optical plate unit includes a light output surface and a bottom surface opposite to the light output surface. A plurality of first protrusions are formed on the light output surface. A lamp-receiving portion is defined in the bottom surface. The light output portion is received in the lamp-receiving portion.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and a backlight module using the optical plate. Moreover, in the drawings, like reference numerals designate corresponding parts throughout the several views, and all the views are schematic.

FIG. 1 is a side cross-sectional view of a backlight module according to a first preferred embodiment of the present invention.

FIG. 2 is an isometric view of an optical plate of the backlight module of FIG. 1.

FIG. 3 is a side, cross-sectional view of the optical plate of FIG. 2, taken along line III-III thereof.

FIG. 4 is an enlarged view of a circled portion IV of FIG. 1.

FIG. 5 is a side, cross-sectional view of an optical plate according to a second preferred embodiment of the present invention.

FIG. 6 is a side, cross-sectional view of an optical plate according to a third preferred embodiment of the present invention.

FIG. 7 is a top plan view of an optical plate according to a fourth preferred embodiment of the present invention.

FIG. 8 is a top plan view of an optical plate according to a fifth preferred embodiment of the present invention.

FIG. 9 is a top plan view of an optical plate according to a sixth preferred embodiment of the present invention.

FIG. 10 is a side, cross-sectional view of a conventional backlight module.

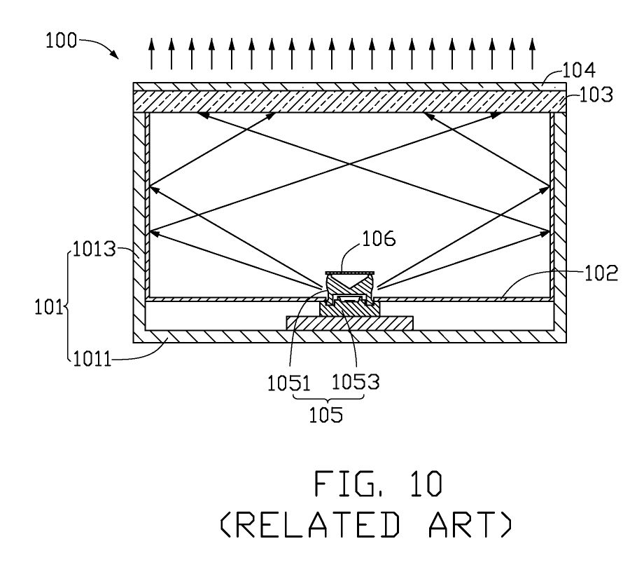

### DETAILED DESCRIPTION OF THE PREFERRED EMBODIMENTS

References will now be made to the drawings to describe preferred embodiments of the present optical plate and backlight module using the optical plate, in detail.

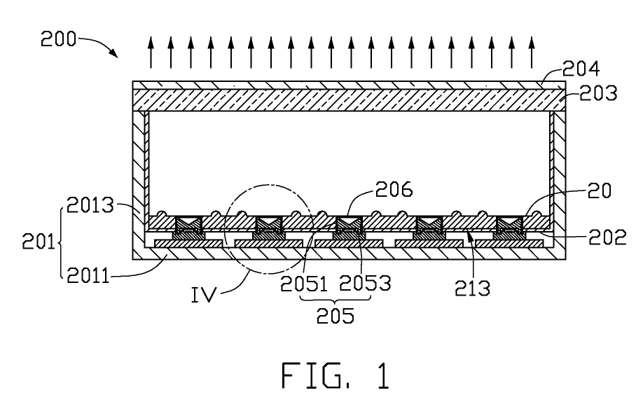

Referring to FIG. 1, a backlight module 200 in accordance with a first preferred embodiment of the present invention is shown. The backlight module 200 includes a housing 201, a light diffusion plate 203, an optical plate 20, a plurality of point light sources 205, and a plurality of reflective members 206. The housing 201 includes a base 2011 and a plurality of connecting sidewalls 2013 extending around a periphery of the base 2011. The base 2011 and the connecting sidewalls 2013 cooperatively define a receiving cavity (not labeled). The point light sources 205 and the optical plate 20 are received in the receiving cavity. The light diffusion plate 203 is positioned on a top of the connecting sidewalls 2013.

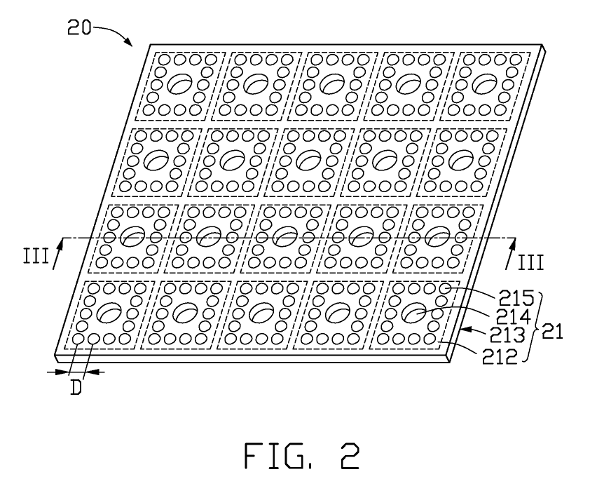

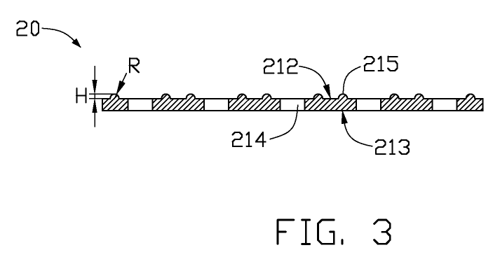

Referring to FIGS. 2 and 3, the optical plate 20 is substantially a rectangular sheet. The optical plate 20 includes a plurality of optical plate units 21 arranged side by side. A thickness of each optical plate units 21 can be in a range from about 0.5 millimeters to about 5 millimeters. Each optical plate unit 21 includes a light output surface 212, and a bottom surface 213 on another side of the optical plate units 21 opposite to the light output surface 212. A plurality of first protrusions 215 are formed on the light output surface 213, and a lamp-receiving portion is 214 defined in the bottom surface 213. In the illustration embodiment, each of the first protrusions 215 is a hemispherical protrusion. The first protrusions 215 are arranged regularly on the bottom surface 213 in a matrix manner, and further, each of the first protrusions 215 adjoins one another. A radius R of each first protrusion 215 can be in the range from about 0.01 millimeters to about 2 millimeters. A height H of each first protrusion 215 can be in a range from about 0.01 millimeters to the radius R. A pitch D of two adjacent first protrusions 215 is preferably in a range from about a half of the radius R to about a quadruple of the radius R (i.e., R/2 to 4R). The lamp-receiving portion 214 is defined in a middle portion of the bottom surface 213. The lamp-receiving portion 214 is a through hole that runs through the bottom surface 213 and the light output surface 212.

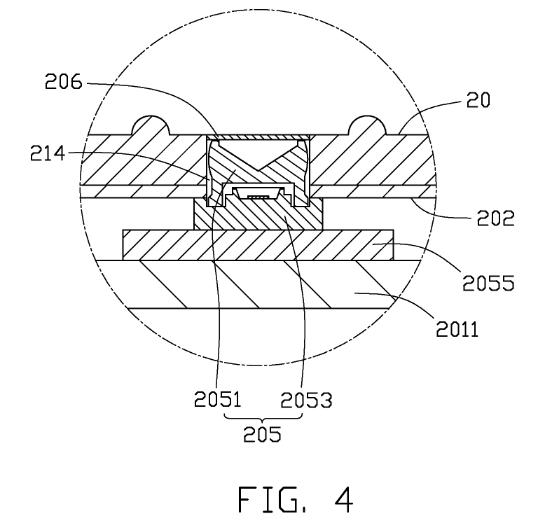

Referring to FIG. 4, the optical plate 20 is located above the base 2011 of the housing 201. The light output surface 212 faces the light diffusion plate 203, and the bottom surface 213 is near the base 2011.

Each point light source 205 can be a light emitting diode. In the preferred embodiment, each point light source 205 includes a base portion 2053 and an output portion 2051 on the base portion 2053. The base portion 2053 is electrically connected with the printed circuit board 2055 that is fixed on the base 2011. The output portion 2051 is substantially received in the lamp-receiving portion 214. Each reflective member 206 is positioned at a top of the output portions 2051 correspondingly. In the illustration embodiment, each reflective member 206 is substantially a rectangular reflective sheet. It should be pointed out that, the reflective member 206 can be also positioned on the light output surface 212 of the optical plate 20 above the lamp-receiving portion 214.

Light from the point light source 205 enters the optical plate 20 through sidewalls of the lamp-receiving portion 214. Since a surface structure of each of the first protrusions 215 changes gradually and continuously, a first amount of light projected on the first protrusions 215 is refracted to a predetermined direction, thereby changing a light path of the first amount of the light exiting the light output surface 212. For example, when light hits the first protrusions 215, the first amount of light is refracted to the first predetermined direction that is normal to the light output surface 212, thereby increasing light that exits the light output surface 212 at a direction normal to the light output surface 212. Thus, dark areas between the point light sources 205 are brightened, and a brightness distribution of the 200 is more uniform.

Furthermore, because of the reflective member 206, brightness directly above the point light source 205 of the backlight module 200 is decreased. Thus the uniformity of distribution of brightness is further improved. In addition, due to the reflective member 206, a volume of the backlight module 200 is reduced.

Referring to FIG. 1, in an alternative embodiment, the backlight module 200 includes a reflective module 202 engaged with the housing 201. A reflective bottom board of the reflective module 202 adjoins to the bottom surface 213 of the optical plate 20. With the inclusion of the reflective module 202, a light energy utilization efficiency of the backlight module 200 is increased.

It is to be understood that, in order to improve brightness of the backlight module 200 within a specific viewing range, the backlight module 200 can further include a prism sheet 204 disposed on the light diffusion plate 203.

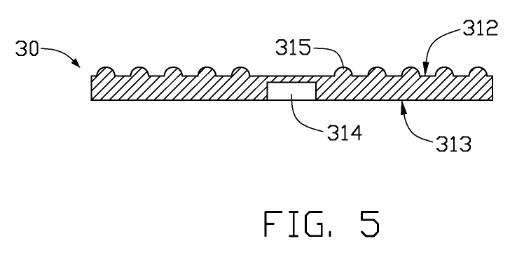

Referring to FIG. 5, an optical plate 30 according to a second preferred embodiment of the present invention is shown. The optical plate 30 is made of an optical plate unit. The optical plate 30 includes a light output surface 312, and a bottom surface 313 on another side of the optical plate 30 opposite to the light output surface 312. A plurality of first protrusions 315 are formed on the output surface 312 and a lamp-receiving portion 314 is defined in the bottom surface 313. Unlike, the first preferred embodiment, in the second preferred embodiment, the lamp-receiving portion 314 is blind hole.

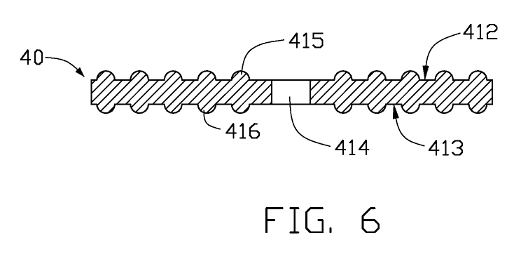

Referring to FIG. 6, an optical plate 40 according to a third preferred embodiment of the present invention is shown. The optical plate 40 is made of an optical plate unit. The optical plate 40 includes a light output surface 412, and a bottom surface 413 on another side of the optical plate 40 opposite to the light output surface 412. A plurality of first protrusions 415 are formed on the light output surface 412. A lamp-receiving portion 414 is defined in the bottom surface 413, and a plurality of second protrusions 416 are formed on the bottom surface 413. The first protrusions 415 and the second protrusions 416 are symmetrical relative to the lamp-receiving portion 414. Since the first protrusions 415 or the second protrusions 416 are arranged symmetrically relative to a center of the optical plate 40, an optical performance such as uniformity of distribution of brightness can be improved.

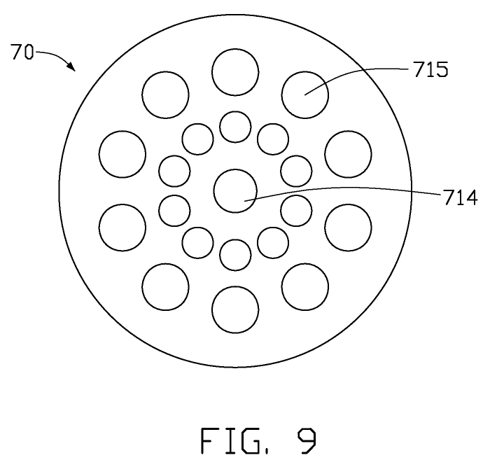

In alternative embodiments, the above optical plate unit can be polygonal or circular. The first protrusions or the second protrusions on the optical plate unit can be arranged randomly or symmetrically relative to a center of the optical plate unit. Referring FIGS. 9 through 9, optical plate 50, 60, and 70 according to fourth to sixth preferred embodiments of the present invention are shown.

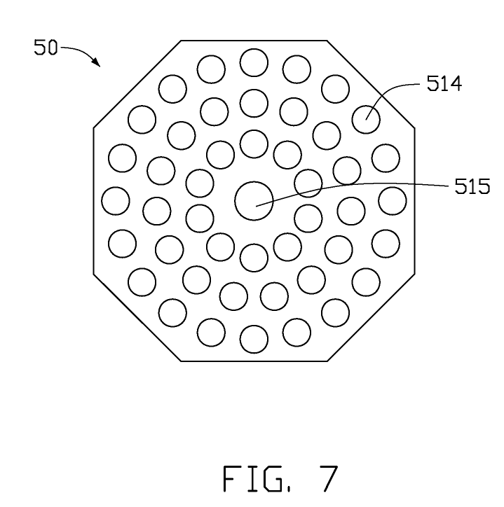

As shown in FIG. 7, the optical plate 50 is made of an optical plate unit. A structure of the optical plate 50 is octagonal. A lamp-receiving portion 514 is defined in a center of the optical plate 50, and first protrusions 515 are arranged on the optical plate 50 in a manner that radiates from the center.

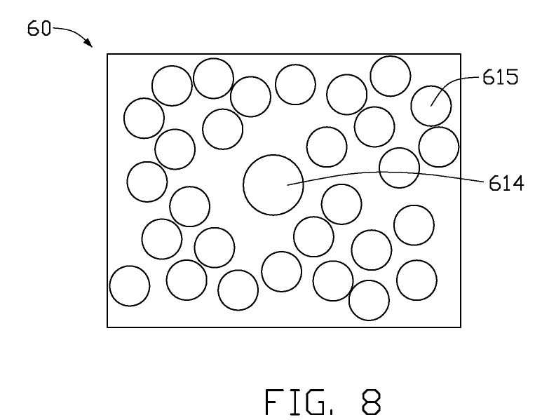

As shown in FIG. 8, the optical plate 60 is made of an optical plate unit. A structure of the optical plate 60 is rectangular. A lamp-receiving portion 614 is defined in a center of the optical plate 60, and first protrusions 615 are arranged randomly relative to the center.

As shown in FIG. 9, the optical plate 70 is made of an optical plate unit. A structure of the optical plate 70 is circular. A lamp-receiving portion 714 is defined in a center of the optical plate 70. First protrusions 715 are arranged on the optical plate 70 in a manner that radiates from the center, and a maximum size of a horizontal cross section of each of the first protrusions 715 progressively decreases with decreasing distance from the center.

It is noted that the scope of the present backlight module is not limited to the embodiments described above. For example, in order to increase brightness of light illumination provided by the backlight module, or mix different wavelength light rays generated by different light emitting diodes to produce white light, each optical plate unit can includes a plurality of lamp-receiving portions for receiving the point light sources. The first protrusions or the second protrusions can also be shaped in the form selected from the group consisting of pyramid, and frustum of pyramid.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. An optical plate, comprising at least an optical plate unit, each optical plate unit comprising a light output surface, and a bottom surface opposite to the light output surface; a plurality of first protrusions formed on the light output surface, and a lamp-receiving portion defined in the bottom surface.

2. The optical plate according to claim 1, wherein each of the first protrusions is shaped in the form selected from the group consisting of hemispheres, pyramids, and frustums of pyramid.

3. The optical plate according to claim 2, wherein a radius of each first protrusions shaped in the form of the sphere is in a range from about 0.01 millimeters to about 2 millimeters; and a height of each of the spherical protrusions is in a range from about 0.01 millimeters to about 2 millimeters.

4. The optical plate according to claim 1, wherein a maximum size of a horizontal cross section of each of the first protrusions progressively decreases with decreasing distance from the lamp-receiving portion.

5. The optical plate according to claim 1, wherein the first protrusions are arranged randomly or symmetrically relative to a center of the optical plate unit.

6. The optical plate according to claim 1, wherein the lamp-receiving portion is at the middle of the optical plate.

7. The optical plate according to claim 6, wherein the lamp-receiving portion is one of a through hole and a blind hole.

8. The optical plate according to claim 1, wherein each optical plate unit further comprises a plurality of second protrusions formed at the bottom surface.

9. A backlight module, comprising:
a housing having a base and a plurality of sidewalls extending from a periphery of the base;
at least a point light source having a light output portion located on the base;
a light diffusion plate positioned on a top of the sidewalls; and
an optical plate comprising at least an optical plate unit, each optical plate unit comprising a light output surface, and a bottom surface opposite to the light output surface; a plurality of first protrusions formed on the light output surface, and a lamp-receiving portion defined in the bottom surface, wherein the light output portion is received in the lamp-receiving portion.

10. The backlight module according to claim 9, wherein the point light source is a light emitting diode, and the backlight module further comprises a reflective member, the reflective member positioned on the light output portion of the point light source, or on the light output surface of the optical plate above the lamp-receiving portion.

11. The backlight module according to claim 9, wherein each of the first protrusions is shaped in the form selected from the group consisting of hemisphere, pyramid, and frustum of pyramid.

12. The backlight module according to claim 11, wherein a radius of each first protrusions shaped in the form of the sphere is in a range from about 0.01 millimeters to about 2 millimeters; and a height of each of the spherical protrusions is in a range from about 0.01 millimeters to about 2 millimeters.

13. The backlight module according to claim 9, wherein a maximum size of a horizontal cross section of each of the first protrusions progressively decreases with decreasing distance from the lamp-receiving portion.

14. The backlight module according to claim 9, wherein the protrusions are arranged randomly or symmetrically relative to a center of the optical plate unit.

15. The backlight module according to claim 9, wherein the lamp-receiving portion is one of a through hole and a blind hole.

16. The backlight module according to claim 9, wherein the optical plate comprises a plurality of optical plate units, the optical plate units arranged side by side.

17. The backlight module according to claim 9, wherein each optical plate unit further comprises a reflective module engaged with the housing, and a bottom board of the reflective module adjoins to the bottom surface of the optical plate.
